(19) United States
(12) Patent Application Publication
(10) Pub. No.: US 2005/0266927 A1
(43) Pub. Date: Dec. 1, 2005

(54) Seamless steel tube for drive shaft and method for manufacturing the same

(76) Inventors: Kouichi Kuroda, Osaka (JP); Tatsuya Okui, Amagasaki-shi (JP); Keisuke Hitoshio, Osaka (JP)

Correspondence Address: CLARK & BRODY, 1090 VERMONT AVENUE, NW, SUITE 250, WASHINGTON, DC, 20005, US

(21) Appl. No.: 11/191,909

(22) Filed: Jul. 29, 2005

Related U.S. Application Data
(63) Continuation of application No. PCT/JP04/00781, filed on Jan. 28, 2004.

(30) Foreign Application Priority Data
Jan. 31, 2003 (JP) 2003-024496

(51) Int. Cl. F16D 3/16

(52) U.S. Cl. 464/183

(57) ABSTRACT

A steel tube hot-finished by the Mannesmann tube-making method is subjected to a simple grinding process for the inner surface, and thereafter to a cold drawing, so that the depth d of the concave portion in the concavo-convex profile forming the inner surface of the steel tube, the surface roughness Ra and the width w of the entrance in the concave portion are specified, or similarly the depth d of the concave portion in the concavo-convex profile, the Vickers hardness Hv of the inner surface layer and the width w of the entrance in the concave portion are specified, hollow parts for a drive shaft, which have an excellent fatigue strength and which is optimal to reduce the weight of a car body, can be produced. Accordingly, the application of the manufacturing method according to the present invention allows drive shafts for automobiles to be efficiently produced in a reduced manufacturing cost, thereby providing a significant advantage in the industry.

### FIELD OF THE INVENTION

The present invention relates to a seamless steel tube for a drive shaft, more specifically a seamless steel tube, which is most suitable to reduce the weight of a drive shaft for an automobile, and which can be used as hollow parts having excellent fatigue strength. The present invention also relates to a method for efficiently manufacturing such a seamless steel tube.

### BACKGROUND ART

In recent years, the necessity of protecting the global environment is more and more increased, and it is further required to realize the weight reduction of a car body of an automobile, along with the enhancement of energy saving. For this purpose, an attempt to reduce the weight of the car body has been made by producing components of an automobile from hollow parts, instead of solid elements. In such an attempt, hollow parts are partially used to manufacture drive shafts of an automobile.

More specifically, in order to reduce the weight of the drive shaft for automobiles more, along with providing the torsion rigidity required for the same, an investigation of employing a drive shaft in the form of a one piece has been made, wherein hollow parts are formed in such a way that they have a smaller thickness at the intermediate portion but an increased diameter and that they have a reduced diameter but an increased thickness at both ends where the hollow elements are fixed to constant velocity universal joints. In order to produce such a drive shaft from a steel tube, a monolithic structure is produced by applying the cold sinking process or the like to the hollow parts at both ends so as to decrease the outside diameter and at the same time to increase the thickness at both ends of the shaft.

The drive shaft for an automobile is a security component, which is essential for transmitting the torque of a rotary shaft of an engine to tires. Since it is preferable that the mechanical strength and rigidity of the drive shaft are enhanced so as to provide the fatigue strength thereof, a heat treatment, such as the quenching or the like, is applied. In the case when the quenching is applied, the strength can be increased up to 981 MPa or more, along with a satisfactory fatigue strength obtained by such a heat treatment.

In the above-mentioned cold sinking process, any inner tools for forming the inner surface of the steel tube are not normally employed, and therefore possible wrinkles appear on the inner surface of the drive shaft after the process, depending upon the conditions for the process. Such wrinkles on the inner surface of the drive shaft cause the fatigue strength to be significantly decreased. In view of this fact, several investigations have been made in which a plug or a mandrel core bar is inserted into the steel tube and then the cold drawing process is repeatedly applied thereto, until the steel tube arrives at a predetermined size.

The repetition of the cold drawing process provides a satisfactory smoothness on the outer and inner surfaces of the steel tube, and also attains such a predetermined size in the finished tube. However, the drawing process and the intermediate annealing process are repeated several times to obtain a smooth inner surface, and therefore cause the manufacturing cost to be increased.

In order to solve the above-mentioned problem, Japanese Patent No. 2822849 has proposed a method for manufacturing a seamless steel tube for a drive shaft or the like in an automobile wherein the seamless steel tube is efficiently produced using a stretch reducer in the Mannesmann tube-making method, and the inside of seamless steel tube is ground by the shot blast grinding or the like. In this manufacturing method, the amount of the material inside-ground by the shot blast is somewhat increased. However, the fatigue strength of hollow parts for a drive shaft can be suitably enhanced by a relatively small amount of the material inside-ground.

The Mannesmann tube-making metod for producing a seamless steel tube in hot working comprises a piercing process for piercing a hole in the center of a solid billet; an elongating process for substantially decreasing the thickness of the hollow tube thus pierced; and a sizing process for reducing the outside diameter of the tube to produce a finished tube having the aimed size.

Traditionally, a piercing mill, such as a Mannesmann piercer, cone type piercer, press piercing mill or the like is used in the piercing process, and a mill, such as a mandrel mill, plug mill, Assel mill or the like is used in the elongating process, and further a caliber rolling mill, such as a stretch reducer, sizer or the like is used in the sizing process.

FIG. 1 is a schematic view exemplifying a system for the manufacturing process in the Mannesmann tube-making method for manufacturing a seamless steel tube in the hot working. In this tube-making process, a round solid billet 1 heated up at a predetermined temperature is used as a material to be rolled, and the round billet 1 is supplied to a piercing mill (so-called piercer) 3, and is then bored along the axial line to produce a hollow shell 2. Subsequently, the hollow shell 2 thus produced is processed as necessary so as to increase the diameter and decrease the thickness by passing through an elongator having the same structure as the piercing mill. Thereafter, it is supplied to a succeeding elongating mill (mandrel mill 4), and then elongated therein.

In the course of the elongating process in the mandrel mill 4, the hollow shell 2 is elongated and, at the same time, cooled by means of both a mandrel bar 4b inserted thereinto and rolls 4r for forming the outer surface of the primary tube. Subsequently, the hollow shell 2 passed through the mandrel mill 4 is inserted into a reheating furnace 5, and then reheated therein. After passing the hollow shell 2 through a stretch reducer 6, a finishing process of polishing the tube surface, correcting the shape and sizing the tube is applied thereto to produce a seamless steel tube.

In such a tube-making process, one or more sets of groove rolls for rolling the hollow shell 2 are arranged along the pass line of the material to be rolled, centering thereon, such that the rolls face each other in the piercer 3, the mandrel mill 4 and the stretch reducer 6.

In the stretch reducer 6, for instance, the hollow shell 2 processed by the piercer 3 and mandrel mill 4 is passed through rolls 6r, and finally formed in a finishing size by the outer diameter reducing process. Therefore, as shown in FIG. 1, the stretch reducer 6 is disposed such that the pass line is conformed to the mill center, and a pair of rolls for rolling the hollow tube 2 consists of three rolls 6r disposed along the pass line, centering thereon, such that they face each other. Several sets of such press rollers 6r are arranged in a tandem configuration. The groove three-roll 6r is displaced between adjacent rolling stands by 60 degrees relative to each other around the pass line.

However, as described above, the hollow shell is produced in the stretch reducer by the outer diameter reducing rolling without usage of the inner tool, such as mandrel, so that the streak-shaped wrinkles in the longitudinal direction frequently appear on the inner surface of the hot-finished steel tube.

In Japanese Patent No. 2822849, it is shown that the fatigue strength of the hot-rolled seamless steel tube is enhanced by an inside-grinding to remove the material by a thickness of 20 μm-500 μm to remove the wrinkles on the inner surface of the steel tube. However, such an inside-grinding process by means of the shot blast causes an extremely longer process time to be required.

In fact, the steel tube used for a drive shaft has a relatively small inside diameter of 15 mm-25 mm, and the shot blast process to obtain the above-mentioned magnitude of material removal on the inner surface requires an extremely longer process time, such as several tens minutes to several hours. It can be stated therefore that the process method according to Japanese Examined Patent Application Publication No. 2822849 provides a serious difficulty in which the production cost increases and the mass production capacity required in the industry cannot be attained.

Since, moreover, three rolls are used for the outer diameter reducing process in the stretch reducer, the hollow shell is rolled in three different directions. As a result, the shape of the inner surface of the hot-finished steel tube exhibits not a true circle, but a multi-edge circle or a polygonal circle. That is, a concavo-convex or rugged profile is formed on the inner surface. It is difficult to correct the concavo-convex profile on the inner surface into a perfect circle only by the grinding process, such as the shot blast or the like.

Moreover, the cold sinking process is applied to the steel tube for a drive shaft at both ends thereof by a swaging machine or the like to manufacture a steel tube varying both the outside diameter and the thickness in the longitudinal direction. The reduction rate of the inside diameter in the cold sinking process becomes approximately 50-70%. If such a process is applied to the steel tube having a concavo-convex profile on the inner surface, wrinkles having a much deeper groove grow starting from the concavo-convex profile.

Normally, a drive shaft used as hollow parts is strengthened by the quenching treatment. Fatigue cracks develop steadily starting from wrinkles in such a strengthened material, thereby causing the fatigue strength to be prominently reduced. Hence, in the tube having a high strength of 981 MPa or more, the stress concentration sensitivity is enhanced by the generation of fatigue cracks, along with the enhancement of the mechanical strength, thereby causing the problems to arise regarding the quality of the inner surface.

### SUMMARY OF THE INVENTION

In view of the problems in the manufacturing a seamless steel tube for a component of an automobile, such as a drive shaft or the like, it is an object of the present invention to provide a seamless steel tube for a drive shaft and a method for manufacturing the same, which are suitable for reducing the weight of the car body and which has an excellent fatigue strength, in which case, the relatively little inside-grinding process is applied and a subsequent cold-drawing process is applied to a hot-finished steel tube produced by the Mannesmann tube-making method.

The present inventors extensively studied the manufacturing method of the seamless steel tube for a drive shaft in order to solve the above problems. The results obtained in the experimental studies reveal that the growth and development of the wrinkles generated in the cold sinking process do not necessarily depend on the depth of the wrinkle in the tube after hot rolled, and that the fatigue service life of the drive shaft as a final product does not only depend on the depth of the wrinkles appearing on the inner surface of the steel tube before the cold sinking process. In the following, the experimental results clarified by the present inventors will be described:

A drive shaft is regarded as a safety component, which is essential for transmitting the torque in an engine of an automobile from the rotary shaft to the tire, so that it is preferable to suppress the generation of wrinkles on the surfaces, which provide a possible origin of starting the fatigue fracture. In the process of finishing the final products from the hollow tube, the cold sinking process is applied to the steel tube at both ends thereof, so that a drive shaft in the form of a one-piece, i.e., monolithic construction, is produced.

However, in the cold sinking process, there is a possibility that the wrinkles on the inner surface are generated and grown from the concavo-convex profile formed on the inner surface in a plane vertical to the longitudinal direction of the steel tube. In view of this fact, it is necessary to evaluate the performance of the hollow parts used for the drive shaft at a stage of having applied the cold sinking process thereto to finish the final products.

From the above viewpoint, it can be stated that the manufacturing method proposed in Japanese Examined Patent Application Publication No. 2822849 provides an increase in the manufacturing cost as well as a reduction in the productive efficiency, because the wrinkles on the inner surface are removed in the hot-finished steel tube before the cold sinking process, that is, at the stage of treating semi-finished products for a drive shaft.

In other words, the depth of the wrinkles before the cold sinking process in the steel tube for a drive shaft by means of not reducing, but rather clarifying the quality of the inner surface of the steel tube which can suppress the development of the wrinkles grown on the inner surface in the subsequent cold sinking process, an allowable depth of the wrinkles before the cold sinking process is ascertained. As a result, a predetermined fatigue strength can be efficiently obtained at a reduced manufacturing cost without inside-grinding for long time.

FIG. 2 is a conceptual diagram representing the distribution of shear stress on the inner and outer surfaces of a drive shaft in the case when the torque of a rotary shaft is transmitted. As is clearly seen from the distribution of the shear stress shown in FIG. 2, the outer surface of the drive shaft is subject to a larger shear stress than the inner surface.

Consequently, when the fatigue limiting shear stress is sufficiently large in the state of no wrinkle on the inner surface of the drive shaft, the fatigue cracks are generated and develop on the side of the outer surface, to which a large shear stress is applied, compared with the inner surface.

When, however, there exist wrinkles on the inner surface, cracks develop from the wrinkles as starting points. As a result, there is a possibility that the fatigue cracks develop from the inner surface side even if the shear stress applied thereto is small.

In other words, if the wrinkles on the inner surface can be controlled in such a way that the tolerable shear stress due to the fatigue on the inner surface is greater than the shear stress on the outer surface, the wrinkles generated and developed in the cold sinking process provides no influence on the service life of the products, and therefore practically provides no problem, even if the wrinkles reside on the inner surface.

On the basis of the above knowledge, the present invention has been accomplished by clarifying both the conditions of obtaining a sufficient fatigue property for a drive shaft in the form of a one-piece and the method of efficiently manufacturing such hollow parts. The object of the present invention is attained by the following measures:
(1) A seamless steel tube for a drive shaft is provided, wherein the concavo-convex profile forming the inner surface in a section vertical to the longitudinal direction of the steel tube has a depth d of 100 μm or less in the bottom of a concave portion, wherein the surface roughness of the inner surface of the steel tube is a centerline average roughness Ra of 1-4 μm, and wherein a width w of the entrance in the concave portion is 0.5 d or more, when the depth d of the bottom in the concave portion is 50 μm or more.
(2) A seamless steel tube for a drive shaft is provided, wherein the concavo-convex profile forming the inner surface in a section vertical to the longitudinal direction of the steel tube has a depth d of 100 μm or less in the bottom of a concave portion, wherein the hardness of the inner surface layer at a depth of 500 μm of the steel tube is a Vickers hardness of 200 or less, and wherein a width w of the entrance in the concave portion is 0.5 d or more, when the depth d of the bottom in the concave portion is 50 μm or more.
(3) A method for manufacturing a seamless steel tube for a drive shaft is provided, wherein the seamless steel tube is reheated at 800-1050° C. after an elongating mill process, and then subjected to a sizing mill process under a condition that the maximum ovality of roll groove (long radius/short radius) is 1.1 or less, and then the inner surface of the hot-finished steel tube is ground by sand blast, and subsequently said steel tube is cold-rolled, in the course of a process where the seamless steel tube is hot worked by the Mannesmann tube-making method.

In the seamless steel tube for a drive shaft according to the above (1) and (2) of the invention, the fatigue strength necessary for a drive shaft can be obtained after the cold sinking process for any width w of the entrance in a concave portion, if the depth d of the bottom in the concave portion is less than 50 μm.

Accordingly, no restriction is made to the width w of the entrance in the concave portion in the case when the depth d of the bottom in the concave portion is less than 50 μm.

The terminology “concavo-convex profile forming the inner surface” used herein implies the quality status of the inner surface before the cold sinking process regarding a seamless steel tube for a drive shaft. More specifically, the terminology implies the status of wrinkles generated on the inner surface, which wrinkles originate from the generation of wrinkles on the multi-edge surface and the polygonal surface or streak-shaped wrinkles in the longitudinal direction on the inner surface of the hot-finished steel tube, which wrinkles are subjected to the subsequent inside-grinding and/or the cold drawing. In the following description, therefore, the expressions “concavo-convex profile” and “wrinkles on the inner surface” are used in the same meaning.

### BRIEF DESCRIPTION OF THE DRAWINGS

FIG. 1 is a schematic perspective view of a system for manufacturing a seamless steel tube in the hot work with the Mannesmann tube-making method for explaining the manufacturing process.

FIG. 2 is a conceptual diagram representing the distribution of the shear stress applied onto the inner surface and outer surface of a drive shaft in the case when a torque in a rotary shaft is transmitted.

FIG. 3 illustrates micrographs in which streak-shaped wrinkles and multi-edged surface generated on the inner surface of a steel tube are shown as the concavo-convex profile forming the inner surface in a section vertical to the longitudinal direction of the steel tube.

FIG. 4 is a sectional view of a roll in a stretch reducer for showing the shape of a roll groove, and

FIG. 5 is a sectional view of a test piece used in Examples for evaluating the fatigue property.

### BEST MODE FOR CARRYING OUT THE INVENTION

Referring now to the accompanying drawings and tables, the preferred embodiments of the invention will be described. In the seamless steel pipe for a drive shaft according to the invention, the concavo-convex profile forming the inner surface is controlled within a predetermined range in order to obtain an excellent fatigue strength for a drive shaft, as for not only the averaged size in the concavo-convex profile, but also the concavo-convex profile having the maximum size, over all the profiles on the inner surface of the steel tube.

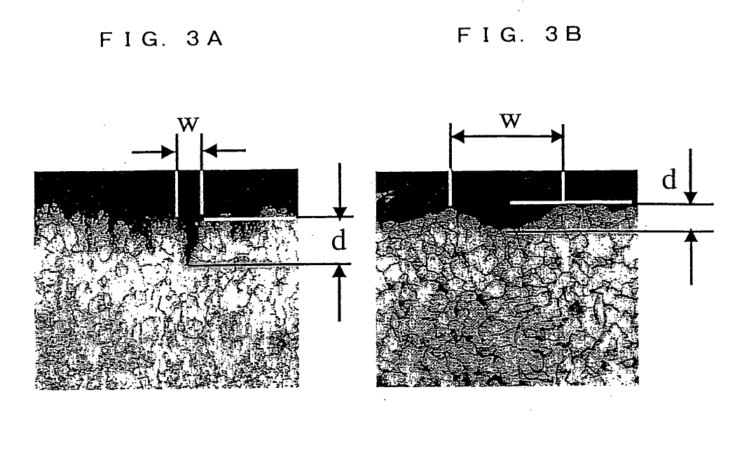

FIG. 3 illustrates micrographs, in which streak-shaped wrinkles and the multi-edged shape generated on the inner surface of a steel tube are shown as a concavo-convex profile forming the inner surface in a plane vertical to the longitudinal direction of the steel tube, where the width of the entrance in the concave portion is small in the micrograph (a) and the width of the entrance in the concave portion is large in the micrograph (b). In order to evaluate the size of the concavo-convex profile discretely formed on the inner surface of the steel tube, the depth of the bottom in the concave portion and the width of the entrance in the concave portion are defined by d and w, respectively, as shown in FIG. 3.

In order to obtain a satisfactory fatigue strength, under a prerequisite condition that d is 100 μm or less, w is controlled so as to become 0.5 d or more, when the depth of the bottom in the concave portion is relatively large, that is, d is 50 μm or more.

When, however, the depth of the bottom in the concave portion is small, that is, d is less than 50 μm, the fatigue strength necessary for a drive shaft after the cold sinking process can be always obtained for any value of the width w of the entrance in the concave portion. Accordingly, no limitation is provided for the width w of the entrance in the concave portion.

Moreover, in the seamless steel tube according to the invention, it is necessary to control the index of level for the concavo-convex profile in average within a predetermined range by measuring the concavo-convex profile on the inner and outer surfaces of the steel tube over a predetermined length. That is, the surface roughness on the inner and outer surfaces of the steel tube is controlled so as to obtain a centerline average roughness Ra of 1-4 μm. The centerline average roughness Ra used herein is the same as that defined by JIS B0601.

As described above, in the outer diameter reducing rolling in the stretch reducer, the hollow shell is subjected to the rolling in three different directions by three rolls with respect to the pass line. However, a number of streak-shaped wrinkles and multiple edges appear on the inner surface because any inner tool is not used. A subsequent drawing process allows the streak-shaped wrinkle and edges to be reduced, along with the smoothing of the entire inner and outer surfaces.

In accordance with the investigations made by the present inventors, it is found that the centerline average roughness Ra of 5-10 μm at most is obtained for a steel tube hot-finished by the rolling in a stretch reducer, while the cold drawing process allows the surfaces to be smoothened at a centerline average roughness Ra of 1-4 μm, thereby enabling the fatigue service life to be prominently improved. As a result, it is necessary to maintain the roughness on the inner surface in a centerline average roughness Ra of 1-4 μm for the steel tube according to the invention.

As described above, the control of the concavo-convex profiles having a relatively large size within a predetermined range, among the concavo-convex profiles forming the inner surface of the steel tube, as well as control of the average level index for the concavo-convex profile on the inner surface of the steel tube allows the development of the wrinkles to be suppressed in the cold sinking process at the final stage, with a combined effect thereof, thereby enabling the fatigue strength to be enhanced.

The amount of diameter reduction in the cold sinking process depends on the shape of the drive shaft to be manufactured. Generally, it is preferable to set the reduction rate of the outside diameter in 30% and the reduction rate of the inside diameter in approximately 60%. Within such an amount of diameter reduction in the cold sinking process, the above-mentioned conditions for the concavo-convex profile of the inner surface of the steel tube according to the invention as well as for the surface roughness of the inner and outer surfaces thereof allow the fatigue strength to be markedly enhanced.

In another seamless steel tube for a drive shaft according to the invention, the control of the concavo-convex profiles having a relatively large size within a predetermined range, among the concavo-convex profiles forming the inner surface of the steel tube, as well as the providing of Vickers hardness Hv≦200 for the hardness of the steel tube at an inner surface layer depth of 500 μm allows an excellent fatigue strength to be obtained for the drive shaft, as similarly to the above case, even if the amount of diameter reduction in the cold sinking process is relatively larger.

The hardness of the steel at the inner surface layer depth of 500 μm used in this case means an average of the hardness values measured at respective radial distances of 100 μm, 200 μm, 300 μm, 400 μm and 500 μm from the side of the inner surface in a cross section vertical to the longitudinal direction of the steel tube.

An investigation of the influence of the hardness distribution on the wrinkle generation on the side of the inner surface reveals that a change in the hardness on the side of the outer surface within a certain range does not directly influence on the wrinkle generation on the side of the inner surface. Since, moreover, in the cold sinking process, the inner tool provides a shear deformation for the material in the vicinity of the uppermost layer at a depth of several μm to several tens μm on the side of the inner surface, the hardness is somewhat increased, compared with the average hardness distribution in the portion of a greater thickness. Anyway, a close examination of the results obtained in the measurement of the Vickers hardness at an inner surface layer of 500 μm reveals a correlation between the hardness and the development of the wrinkles.

In the seamless steel tube according to the invention, no explicit specification is given for the chemical composition in the steel type concerned. However, an example of the chemical composition suitable for use in a drive shaft is as follows: C: 0.20-0.50%, Si: 0.1-0.5% and Mn: 0.4-2.0%, and the residual being Fe and impurities, such as P, S and others.

In order to further improve the properties other than the fatigue strength along therewith, one or more compositions of Cr: 0-1.5%, Ti: 0-0.05%, Nb: 0-0.05%, V: 0-0.1%, Mo: 0-1%, Ni: 0-0.5%, Cu: 0-0.5%, B: 0-0.05% and Ca: 0-0.01% can be added to the above composition.

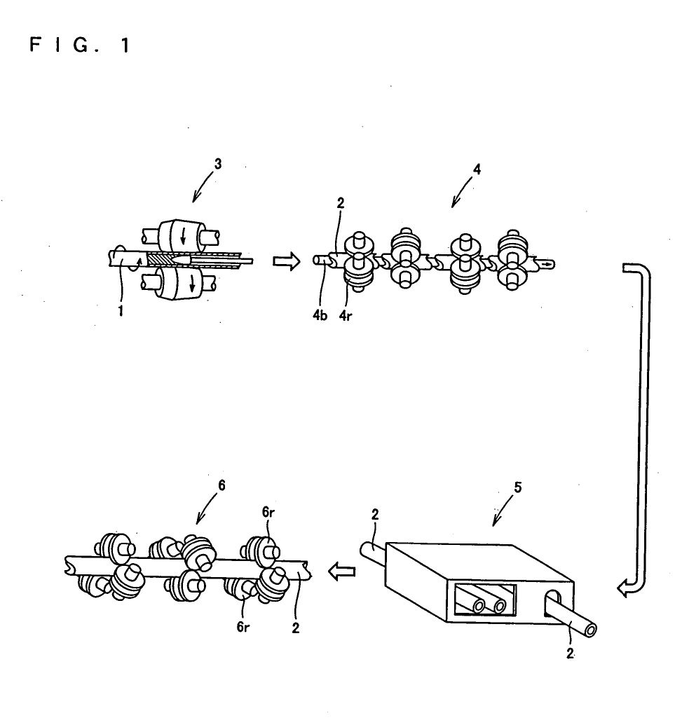

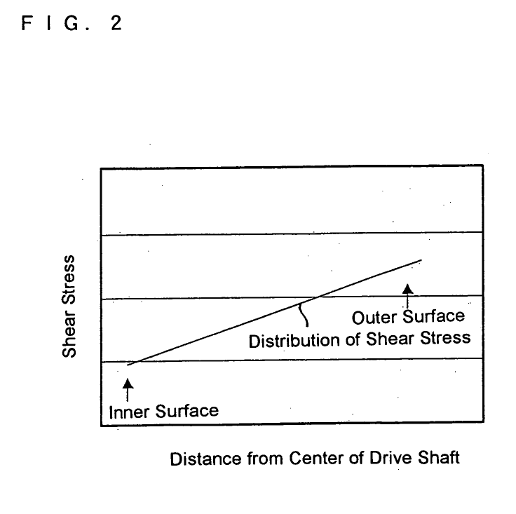

As an example of the method for manufacturing the steel tube according to the invention, the Mannesmann tube-making method with a mandrel mill and a stretch reducer can be employed, as shown in FIG. 1.

More specifically, in the tube-making process of a seamless steel tube under the hot working condition, the tube is reheated at 800-1050° C. after rolling in the mandrel mill, and the temperature for rolling in the stretch reducer is sufficiently increased and homogenized. Thus, the roundness of the inner surface of the steel tube can be appropriately enhanced with the stretch reducer, and further the generation of the polygonal edges on the inner surface can be efficiently suppressed.

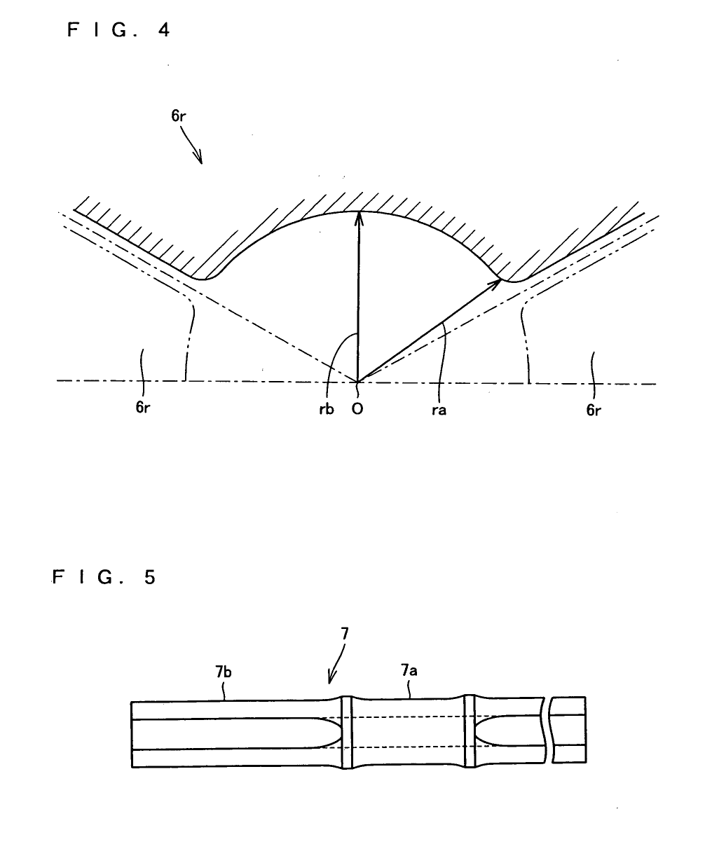

FIG. 4 is a sectional view of a roll in a stretch reducer for showing the shape of a roll groove. As described above, a mill stand disposed in the stretch reducer has three rolls 6r. Normally, the shape of the roll groove in the rolls 6r is determined by the maximum ovality of the roll groove defined by the ratio of the long radius ra to the short radius rb of the roll groove.

In the manufacturing method according to the invention, when a hollow shell, which is uniformly reheated at a high temperature, is rolled by the stretch reducer, the uniformity in the reduction magnitude can be enhanced, using the rolls having the maximum ovality of roll groove (ra/rb) of 1.1 or less.

By specifying the above-mentioned reheating conditions and the maximum ovality of roll groove (ra/rb) of a roll, the roundness of the inner surface of a steel tube after rolling by the stretch reducer can be enhanced, and the unevenness of the polygonal inner surface can be effectively suppressed. In the manufacturing method according to the invention, as described above, the inner surface of the hot-finished steel tube having a fairly good roundness is ground, and then the smoothness of the inner surface is enhanced by the cold drawing, so that the quality of the inner surface of the steel tube for a drive shaft having an excellent fatigue strength can be efficiently enhanced.

Namely, since the smoothening of the inner and outer surfaces can be carried out by the cold drawing process after the inner surface of the hot-finished steel tube is ground by sand blast, the pre-grinding process by means of sand blast can be simplified relatively with ease, thereby enabling the grinding process to be completed in a short time with a reduced amount of grinding. For instance, as will be described below, the grinding process according to the invention can be realized with a grinding time of about 10 min at a grinding amount of 20 μm-30 μm.

In the cold drawing, moreover, the inner surface is finished such that the inner tool, e.g., a plug, comes into contact with the inner surface of the steel tube, so that the roughness can be suppressed not only for the outer surface but also for the inner surface. The grinding process applied to the hot-finished steel tube provides a centerline surface roughness Ra of 5-10 μm regarding the roughness of the inner surface. However, a further application of the cold drawing process to the steel tube allows the roughness to be smoothened in a centerline surface roughness Ra of 1-4 μm.

The advantages of the steel tube for a drive shaft and the manufacturing method for the same according to the invention will be described in detail, based upon the results obtained in three different

### EXAMPLES 1-3

### EXAMPLE 1

An evaluation test of products was made by inspecting the torsion fatigue strength, either of a steel tube which was applied the cold sinking after hot-finishing and cold drawing or a steel tube which was applied the cold sinking after hot-finishing only. The chemical composition of the test pieces was C: 0.40%, Si: 0.28%, Mn: 1.07%, Cr: 0.14%, Ti: 0.032% and B: 0.0014% in mass %, the residual being Fe.

Firstly, a round billet was rolled to a hollow shell by a piercer, and then elongated by a mandrel mill. Thereafter, it was reheated at 900° C., and then was subjected to the outer diameter reducing rolling in the stretch reducer to produce a hot-finished steel tube having an outside diameter of 51 mm, an inside diameter of 35 mm and a thickness of 8 mm. Thereafter, the hot-finished steel tube was subjected to the inside-grinding by sand blast, varying the grinding time under different conditions.

Subsequently, the steel tube whose inner surface was ground was subject to a pickling treatment, and further to a lubricating treatment, and then cold drawn, using a cylindrical plug. Finally, the steel tube thus cold drawn was annealed at 700° C. for 20 min to produce a steel tube for a drive shaft having an outside diameter of 45 mm, an inside diameter of 31 mm and a thickness of 7 mm.

In order to confirm the effect of the cold drawing, in a Comparative Example, a stretch reducer was used to roll a hollow shell and thus to produce a hot-finished steel tube having an outside diameter of 45 mm, an inside diameter of 31 mm and a thickness of 7 mm. The inside-grinding was carried out, as similarly to the above procedure, and then a steel tube for a drive shaft was produced.

Subsequently, each of the steel tubes thus produced was divided into pieces each having a 500 mm length, and further sliced at both ends of the tube to prepare specimens for observing the microstructure on the inner surface of the steel tube. Then, the concavo-convex profile appearing on the inner surface of the steel tube in a section vertical to the axial direction thereof was microscopically observed.

In the microscopic observation, the maximum depth dmax of the bottom in the concave portion was measured in a cross section vertical to the longitudinal direction, along with the width w of the entrance for concave portions each having a depth d of 50 μm or more, to determine the ratio of w/d in the inspection. Moreover, the surface roughness Ra of the respective steel tubes for a drive shaft was measured for both the inner surfaces.

Furthermore, these steel tubes for a drive shaft were subjected to the cold sinking process at a reduction rate of about 30%. Thereafter, the fatigue service life of the steel tube was evaluated for the respective final products of the drive shafts. The dimension of each test piece in the evaluation was determined such that it had an outside diameter of 32 mm, an inside diameter of 14 mm and a thickness of 9 mm, and the reduction rate of the inside diameter in the cold sinking process was set about 55%. It is found that a difference in the growth state of the wrinkles in the cold sinking process appears in accordance with the different quality of the inner surface for the respective test pieces of the steel tubes for a drive shaft and the status was evaluated in a result of the fatigue test.

As shown in FIG. 5, a test piece 7 for evaluating the fatigue property was prepared by slicing off the test section 7a having a parallel outer surface within an appropriate range at the center part to form grip portions 7b on both ends thereof. The respective test pieces having such a shape as shown in FIG. 5 were quenched and then tempered. Thereafter, the torsion fatigue test was carried out for these test pieces by varying the torque load applied thereto.

The test conditions and the results obtained in the test are summarized in Table 1, where one type of the test steel tubes for a drive shaft is cold drawn after hot finished, and the other type is hot finished only.

TABLE 1

| | | | | | Results of Fatigue | | |
|---|---|---|---|---|---|---|---|
| | Conditions of Test Steel Tube | | | | Test | | |
| | Size of Concave | | | | Torsion | | |
| Test | Portion | | | Surface | Load | Location | |
| Piece | d max | | Cold | Roughness | Torque | of | |
| No. | (μm) | w/d | Drawing | Ra (μm) | (N · m) | Fracture | Classification |
| 1 | *200 | 1.10 | non | *7.5 | 1900 | Inner | Comparative |
| | | | | | | surface | Example |
| 2 | *125 | *0.35 | non | *8.5 | 1700 | Inner | Comparative |
| | | | | | | surface | Example |
| 3 | 85 | 0.85 | used | 3.5 | 3100 | Outer | Inventive |
| | | | | | | surface | Example |
| 4 | 80 | *0.35 | used | 1.8 | 2200 | Inner | Comparative |
| | | | | | | Surface | Example |
| 5 | 80 | *0.30 | non | *6.5 | 2000 | Inner | Comparative |
| | | | | | | Surface | Example |
| 6 | 75 | 0.62 | used | 4.5 | 3100 | Outer | Inventive |
| | | | | | | Surface | Example |
| 7 | 65 | *0.40 | used | 1.8 | 2400 | Inner | Comparative |
| | | | | | | Surface | Example |
| 8 | 60 | 0.75 | used | 2.5 | 3100 | Outer | Inventive |
| | | | | | | Surface | Example |
| 9 | 35 | 0.25 | used | 2.2 | 3100 | Outer | Inventive |
| | | | | | | surface | Example |

Note)
Mark * in the table means the outside of the range specified in the present invention.

The magnitude of torque load in the fatigue test after the cold sinking process became high in the following case. The concavo-convex profile forming the inner surface in a cross section vertical to the longitudinal direction of the steel tube has a depth d of 100 μm or less for the bottom of the concave portions, the width w of the entrance in the concave portion is 0.5 d or more (w/d≧0.5), where the bottom depth d of the concave portions is 50 μm or more, and the roughness of the inner surface is 1-4 μm in a centerline average roughness Ra.

In this case, the centerline average roughness Ra was determined by measuring the roughness on the cut surface of test pieces, which were prepared by dividing a steel tube along its axis into two pieces in the longitudinal direction.

On the other hand, it is found that, if the inner surface is so smooth as the maximum depth d max of the bottom in the concave portion becomes less than 50 μm, no fracture starting on the side of the inner surface appears, even when the width w of the entrance of the concave portion does not fulfill the above-mentioned condition (test piece No. 9).

As described above, in Example 1, the cold drawing of the hot-finished steel tube causes the surface roughness Ra to be improved, thereby enabling the fatigue property of the steel tube for a drive shaft to be markedly improved, along with the combined effect of both the control of the concavo-convex profile and the smoothness of the inner surface of the steel tube.

### EXAMPLE 2

After applying the hot work process and grinding process, as similarly to those in Example 1, a steel tube for a drive shaft was produced in the cold drawing process. In the case when the steel tube, which was prepared by applying the cold sinking thereto at a reduction rate of about 38%, was used as a final product of a drive shaft, the fatigue service life of the steel tube was evaluated.

The evaluated steel tube had an outside diameter of 28 mm, an inside diameter of 9 mm and a thickness of 9.5 mm. The reduction rate of the inside diameter in the cold sinking process was about 71%, so that the fatigue property was evaluated in severer conditions than those in Example 1.

In the evaluation, section specimens for observing the microstructure were prepared, as similarly to Example 1, and d max and w/d were determined for these specimens, together with the measurement of Vickers hardness Hv of the inner surface layer of the steel tube at a depth of 500 μm.

In this case, the hardness of the inner surface layer of the steel tube at a depth of 500 μm was measured for the specimens, which were obtained by tempering the steel tube at 780-790° C. before the cold sinking process and by varying the period of the subsequent cooling. Test conditions and the results obtained in the test are summarized in Table 2.

TABLE 2

| | Conditions of Test | | | | | |
|---|---|---|---|---|---|---|
| | Steel Tube | | | Results of | | |
| | Size of | | | Fatigue Test | | |
| | Concave | | Hardness | Torsion | | |
| Test | Portion | | of Inner | Load | Location | |
| Piece | d max | | Surface | Torque | of | |
| No. | (μm) | w/d | (Hv) | (N · m) | Fracture | Classification |
| 10 | *200 | 1.50 | *215 | 850 | Inner | Comparative |
| | | | | | surface | Example |
| 11 | *130 | *0.30 | *205 | 1000 | Inner | Comparative |
| | | | | | Surface | Example |
| 12 | 95 | *0.40 | *220 | 1400 | Inner | Comparative |
| | | | | | Surface | Example |
| 13 | 95 | 0.90 | 190 | 2200 | Inner | Inventive |
| | | | | | Surface | Example |
| 14 | 90 | 0.85 | 183 | 2350 | Inner | Inventive |
| | | | | | Surface | Example |
| 15 | 85 | 0.55 | 186 | 2400 | Inner | Inventive |
| | | | | | Surface | Example |
| 16 | 65 | 0.75 | 165 | 2700 | Outer | Inventive |
| | | | | | Surface | Example |

Note)
Mark * in the table means the outside of the range specified in the present invention.

From the results shown in Table 2, it is found that the fatigue strength is enhanced, when the hardness of the inner surface layer is Hv≦200 in the Vickers hardness, for specimens in which the concavo-convex profile forming the inner surface has a depth d of 100 μm or less for the bottom of the concave portion in a cross section vertical to the longitudinal direction of the steel tube and, at the same time, the width w of the entrance in the concave portion is 0.5 d or more (w/d≧0.5), where the depth d of the bottom in the concave portion is 50 μm or more.

Moreover, it is found that if Hv≦180 is preferably maintained, the fatigue property is further improved.

### EXAMPLE 3

The manufacturing conditions according to the invention are as follows. The chemical composition of the test materials is determined such that it contains C: 0.45%, Si: 0.23%, Mn: 0.76% and Cr: 0.16% in mass %, the residual being Fe.

As shown in FIG. 1, a round billet was rolled to a hollow shell by a piercer in the Mannesmann tube-making method, and then the tube was rolled to reduce the thickness in a mandrel mill. Thereafter, the tube was reheated at 900° C. in a reheating furnace.

In the subsequent stretch reducer, the hollow shell thus reheated was rolled with 20 sets of three-roll stands. In this case, the primary tube was rolled by tandem roll stands, without using either mandrel bar or the other core bar.

The steel tube thus hot-finished by the stretch reducer was subject to the inside-grinding by sand blast, and further pickled and then lubricated. Thereafter, the tube was subjected to the cold drawing, using a cylindrical plug, and then annealed at 700° C. for 20 min to produce a steal tube for a drive shaft having an outside diameter of 45 mm, an inside diameter of 31 mm and a thickness of 7 mm.

In order to ascertain the dependence of the fatigue property on the manufacturing process, as similarly to Example 1, a hot-finished steel tube after rolling by a stretch reducer having an outside diameter of 45 mm, an inside diameter of 31 mm and a thickness of 7 mm was made, and the steel tube thus rolled was then annealed at 700° C. for 20 min after the inside-grinding to produce a steal tube for a drive shaft, as a Comparative Example for confirming the effect of the cold drawing.

The steel tube for a drive shaft thus prepared before application of the cold sinking process has a Vickers hardness Hv of 193-196 at the inner surface layer depth of 500 μm.

Moreover, as similarly to Example 1, a steel tube for a drive shaft was further cold sunk at an outside diameter reduction rate of about 30%, and finally quenched. The fatigue service life was evaluated as a final product of a drive shaft. The specimen in the evaluation has an outside diameter of 32 mm, an inside diameter of 14 mm and a thickness of 9 mm.

The concavo-convex profile of the inner surface, the surface roughness, the usage/non-usage of the cold drawing, the time of the inside-grinding by sand blast and the fatigue service life determined by these parameters are summarized in Table 3.

TABLE 3

| | Conditions of Test Steel Tube | | | | | | | |
|---|---|---|---|---|---|---|---|---|
| | Size of | | | | | Results of | | |
| | Concave | | | | | Fatigue Test | | |
| | Portion | | Inside- | | | Torsion | | |
| Test | d | | grinding | | Surface | Load | Location | |
| Piece | max | | Time | Cold | Roughness | Torque | of | |
| No. | (μm) | w/d | (min) | Drawing | (μm) | (N · m) | Fracture | Classification |
| 17 | *200 | 1.10 | 10 | non | *8.5 | 1400 | Inner | Comparative |
| | | | | | | | surface | Example |
| 18 | *110 | 0.55 | 30 | non | *7.5 | 1800 | Inner | Comparative |
| | | | | | | | Surface | Example |
| 19 | 90 | 0.55 | 150 | non | *6.5 | 1700 | Outer | Comparative |
| | | | | | | | Surface | Example |
| 20 | 85 | *0.40 | 200 | non | *7.5 | 2300 | Inner | Comparative |
| | | | | | | | Surface | Example |
| 21 | 80 | 0.85 | 10 | used | 2.5 | 2900 | Outer | Inventive |
| | | | | | | | Surface | Example |
| 22 | 76 | 0.62 | 10 | used | 1.9 | 2900 | Outer | Inventive |
| | | | | | | | Surface | Example |
| 23 | 30 | 0.75 | 10 | used | 3.3 | 2900 | Outer | Inventive |
| | | | | | | | Surface | Example |

Note)
Mark * in the table means the outside of the range specified in the present invention.

As is clearly seen in Table 3, the steel tube for a drive shaft has an excellent fatigue strength without spending a long time for the inside-grinding, so long as the steel tube is manufactured under the conditions defined by the present invention.

The amount of the material to be ground depends on the inside diameter of the steel tube, and it is confirmed that a thickness of 20 μm-30 μm is sufficient for the required removal. The cold drawing process after the grinding allows the inner surface of the steel tube to be smoothened, thereby making it possible to efficiently obtain hollow parts for a drive shaft having an excellent fatigue strength.

### INDUSTRIAL APPLICABILITY

In the seamless steel tube for drive shaft according to the present invention, wherein a steel tube hot-finished by the Mannesmann tube-making method is subjected to a simple grinding process for the inner surface, and thereafter to a cold drawing, so that the depth d of the concave portion in the concavo-convex profile forming the inner surface of the steel tube, the surface roughness Ra and the width w of the entrance in the concave portion are specified, or similarly the depth d of the concave portion in the concavo-convex profile, the Vickers hardness Hv of the inner surface layer and the width w of the entrance in the concave portion are specified, hollow parts for a drive shaft, which have an excellent fatigue strength and which is optimal to reduce the weight of a car body, can be produced. Accordingly, the application of the manufacturing method according to the present invention allows drive shafts for automobiles to be efficiently produced in a reduced manufacturing cost, thereby providing a significant advantage in the industry.

1. A seamless steel tube for a drive shaft, characterized in that the concavo-convex profile forming the inner surface in a cross section vertical to the longitudinal direction of the steel tube has a depth d of 100 μm or less in the bottom of a concave portion, that the surface roughness of the inner surface of the steel tube is a centerline average roughness Ra of 1-4 μm, and that a width w of the entrance in the concave portion is 0.5 d or more, when the depth d of the bottom in the concave portion is 50 μm or more, whereas there is no restriction to the width w of the entrance in the concave portion, when the depth d of the bottom in the concave portion is less than 50 μm.

2. A seamless steel tube for a drive shaft, characterized in that the concavo-convex profile forming the inner surface in a cross section vertical to the longitudinal direction of the steel tube has a depth d of 100 μm or less in the bottom of a concave portion, that the hardness of the inner surface layer at a depth of 500 μm of the steel tube is a Vickers hardness of 200 or less, and that a width w of the entrance in the concave portion is 0.5 d or more, when the depth d of the bottom in the concave portion is 50 μm or more, whereas there is no restriction to the width w of the entrance in the concave portion, when the depth d of the bottom in the concave portion is less than 50 μm.

3. A method for manufacturing a seamless steel tube for a drive shaft, characterized in that the seamless steel tube is reheated at 800-1050° C. after an elongating process, and then subjected to a sizing process under a condition that the maximum ovality of roll groove (long radius/short radius) is 1.1 or less, and then the inner surface of said hot-finished steel tube is ground by sand blast, and subsequently said steel tube is cold-drawn, in the course of a process where the seamless steel tube is hot worked by the Mannesmann tube-making method.

4. A method for manufacturing a seamless steel tube for a drive shaft according to claim 3, characterized in that the amount of the material to be ground is at least 20 μm in the inside-grinding, and then the cold drawing is carried out such that the surface roughness of the inner surface of the steel tube becomes a centerline average roughness Ra of 1-4 μm.
